(19) United States
(12) Patent Application Publication
(10) Pub. No.: US 2026/0036243 A1
(43) Pub. Date: Feb. 5, 2026

(54) VACUUM-INSULATED PIPE ASSEMBLY

(71) Applicant: Airbus Operations Limited, FILTON (GB)

(72) Inventors: Andrew SELBY, BRISTOL (GB); Nebojsa SAKOTA, FILTON (GB)

(21) Appl. No.: 19/274,769

(22) Filed: Jul. 21, 2025

(30) Foreign Application Priority Data
Jul. 31, 2024 (GB) 2411283.1

(51) Int. Cl. F16L 59/065; B64D 37/00; F16L 9/18

(52) U.S. Cl. CPC F16L 59/065; B64D 37/005; F16L 9/18

(57) ABSTRACT

A vacuum-insulated pipe assembly having an outer pipe and an inner pipe within the outer pipe, the inner pipe distanced from the outer pipe to provide a space, the space evacuated to define a vacuum. The vacuum-insulated pipe assembly has an annular wall extending inwardly from the outer pipe and defining an aperture about a central axis, the annular wall defining a closed end of the space. The vacuum-insulated pipe assembly has a first connector connected to the inner pipe, and a second connector extending through the aperture and connected to the first connector. The first connector and the second connector are each hollow and connected such that the inner pipe is in fluid communication with the second connector through the aperture. Also a system and a method for making a vacuum-insulated pipe assembly.

### CROSS-REFERENCES TO RELATED APPLICATIONS

This application claims the benefit of Great Britain Patent Application Number 2411283.1 filed on Jul. 31, 2024, the entire disclosure of which is incorporated herein by way of reference.

### FIELD OF THE INVENTION

The present invention relates to vacuum-insulated pipe assemblies, kits of parts and methods of manufacturing the same; hydrogen fuel systems, and aircraft.

### BACKGROUND OF THE INVENTION

Hydrogen fuel systems for aircraft may comprise vacuum-insulated pipes for transporting cryogenic hydrogen fuel between components of the hydrogen fuel system. Vacuum-insulated pipes employ a vacuum in a space between inner and outer pipes to thermally insulate the cryogenic hydrogen fuel flowing through the inner pipe.

### SUMMARY OF THE INVENTION

A first aspect of the present invention provides a vacuum-insulated pipe assembly comprising an outer pipe and an inner pipe within the outer pipe. The inner pipe is distanced from the outer pipe to provide a space, and the space is evacuated to define a vacuum. The vacuum-insulated pipe assembly comprises an annular wall extending inwardly from the outer pipe and defining an aperture about a central axis, the annular wall defining a closed end of the space. The vacuum-insulated pipe assembly comprises a first connector connected to the inner pipe, and a second connector extending through the aperture and connected to the first connector. The first connector and the second connector are each hollow and connected such that the inner pipe is in fluid communication with the second connector through the aperture.

By extending through the aperture, the second connector can be connected to the first connector even when the first connector is entirely located on the same side of the annular wall as the inner pipe. This may permit a “blind” connection of the inner pipe to the second connector during manufacture of the pipe assembly. For instance, the outer pipe may be passed over the inner pipe, and there may be no or limited access to the first connector from within the outer pipe, such as within the space, due to the presence of the inner pipe. This is particularly the case for vacuum-insulated pipe assemblies that are long and/or narrow relative to an operator's hand or arm. The second connector, in contrast, may be more readily accessible from an opposite side of the wall to the inner pipe and first connector, such as when the annular wall extends inwardly towards the common general axis from an end of the outer pipe. Thus, the second connector, by extending through the aperture, may be more easily manipulated to facilitate connection of the first and second connectors, thereby providing a convenient way to manufacture the vacuum-insulated pipe assembly.

Optionally, the second connector comprises an elongate portion, such as a tubular wall, that extends through the aperture to connect to the first connector. Optionally, the first connector defines a first conduit, and the elongate portion of the second connector extends through the aperture and into the first conduit. Optionally, the tubular wall of the second connector defines a second conduit extending through the second connector. Optionally, the elongate portion extends partly into the first conduit and the second conduit opens into the first conduit. Optionally, the second conduit extends through the first conduit and opens into the inner pipe.

The vacuum in the space provides a thermally-insulating barrier between the inner pipe and the outer pipe. This may reduce a rate of heat transfer between the fluid flowing through the inner pipe and an external atmosphere external to the outer pipe, in use, compared to a space filled with a gas, such as atmospheric air.

Optionally, the first and second connectors comprise reciprocal threaded portions connecting the first connector to the second connector. This may provide a convenient way to connect the first and second connectors together, particularly where it is difficult or impossible to access the first connector from within the outer pipe and/or the space. For instance, the second connector, which may be more readily accessible than the first connector, may be rotated to cause engagement of the reciprocal threaded portions.

Optionally, the first conduit comprises an internal thread, and the elongate portion of the second connector comprises an external thread engaged with the internal thread to connect the second connector to the first connector.

Optionally, the second connector is connected in an interference fit with the first connector. The interference fit may provide a fluid-tight seal between the first and second connectors, such as to inhibit a flow of fluid along an interface between the first and second connectors. The interference fit may be in addition to, or an alternative to, the threaded connection between the first and second connectors. For instance, the first and second connectors may comprise reciprocal threaded portions in threaded engagement with each other, and reciprocally sized and shaped surfaces providing an interference fit.

Optionally, one of the first and second connectors comprises a material with a higher coefficient of thermal expansion than the other of the first and second connectors, and the one of the first and second connectors with the higher coefficient of thermal expansion forms an interference fit with the other of the first and second connectors.

In this way, when a temperature of the first and second connectors reduces, such as when the when cryogenic fluid is passed through the inner pipe and the first and second connectors, the connector with the higher thermal expansion coefficient may shrink around the connector with the lower thermal expansion coefficient, which may enhance the interference fit and further seal an interface between the first and second connectors.

Optionally, the first connector has a higher coefficient of thermal expansion than the second connector. Optionally, the portion of the second connector extends into and forms the interference fit with the first connector. Optionally, the portion forms an interference fit with the first conduit of the first connector. The interference fit may provide a seal between the portion of the second connector and the first conduit of the first connector, which may be enhanced when cryogenic fluid is passed through the inner pipe and the first and second connectors.

Optionally, the annular wall comprises a ring extending around the aperture, and the first connector comprises a head engaged with the ring such that an opening of the first connector is aligned with the aperture along a common central axis.

By providing the first connector aligned with the aperture, the second connector may be more easily connected to the first connector such that the inner pipe is in fluid communication with the second connector through the aperture.

The ring may be configured to restrict a relative movement of the first connector and the annular wall in a direction orthogonal to the common central axis. In this way, the ring may assist with locating the first connector relative to the annular wall and the aperture during assembly, which may improve an ease of manufacture of the pipe assembly compared to an assembly without such a ring. This may also improve an ease with which the second connector is connectable to the first connector, for instance by limiting a relative movement of the second connector and the first connector when the first connector is engaged with the ring.

Optionally, the ring and the head comprise reciprocal interlocking elements that inhibit relative rotation of the head and the ring around the common central axis. This may further improve an ease of connection of the second connector to the first connector during manufacture of the vacuum-insulated pipe assembly, compared to an arrangement absent such interlocking elements on the ring and the head. This may particularly be the case when the first and second connectors comprise reciprocal threaded portions. In that case, the first connector may be rotationally fixed in place relative to the ring, and the second connector may be rotated to engage the threaded portions.

Optionally, one of the ring and the head comprises at least one groove and the other of the ring and the head comprises at least one reciprocally-shaped protrusion engaged with the at least one groove to inhibit the relative rotation of the head and the ring around the common central axis. Optionally, one of the ring and the head comprises a plurality of grooves spaced around the common central axis, and the other of the ring and the head comprises a plurality of reciprocally-shaped protrusions spaced around the common central axis and engaged with the plurality of grooves.

Optionally, the pipe assembly comprises a seal element located between the head and the annular wall, the seal element sealing an interface between the head and the annular wall such that the space and the aperture are fluidically isolated from each other.

In this way, the seal element inhibits a flow of fluid along the interface between the first connector and the annular wall. This may, for example, reduce a likelihood of fluid in the space, such as fluid in the space that has leaked from the inner pipe, from passing into the atmosphere external to the outer pipe. This may be particularly advantageous where the inner pipe is configured to carry liquid hydrogen fuel, and the atmosphere comprises oxygen. The seal element may also inhibit a flow of fluid from the atmosphere into the space along the interface, thereby maintaining the vacuum in the space and retaining the thermal insulation properties that the vacuum provides. The seal element may similarly inhibit a flow of fluid from the inner pipe, such as fluid that has passed between the first and second connectors, into the space, thereby fluidically isolating the space and the inner pipe.

Optionally, the connection between the first and second connectors causes the head to be urged towards the annular wall to clamp the seal between the head and the annular wall. Thus, the seal may be deformed, such as elastically or plastically deformed, between the head and the annular wall, thereby improving a sealing effect of the seal.

Optionally, the seal element comprises a metallic gasket. Optionally, at least one of the head and the annular wall comprises a protrusion. Optionally, the protrusion is engaged with the metallic gasket such that the metallic gasket is plastically deformed in the region of the protrusion. Such a plastically-deformed metallic gasket may fill in machining marks and surface defects in the head and the annular wall, providing a hermetic seal. Furthermore, the metallic gasket is work-hardened by the plastic deformation. This provides a strong and resilient metallic gasket that is resilient to movement of the head and/or the annular wall, such as due to expansion or contraction of the head and/or the seat in the event of a change in temperature of the head and/or the annular wall. This may, in turn, provide a seal that is more resilient to changes in temperature than, for example, an elastomeric seal elastically deformed between the head and the annular wall, which may experience greater expansion and/or contraction on exposure to changing temperatures than the metallic gasket, such as when cryogenic fluid is passed through the inner pipe. Thus, the plastically deformed metallic gasket may be more resilient and/or more reliable than an elastomeric seal, particularly when the inner pipe is configured to carry cryogenic fluid, such as cryogenic hydrogen fuel.

During connection of the first and second connectors to each other, such as when screwing the reciprocal threaded portions together, the metallic gasket may be clamped between the head and the annular wall. A force provided by the clamping effect causes the protrusion to engage the metallic gasket and cause the plastic deformation of the metallic gasket in the region of the protrusion.

Optionally, the outer pipe comprises an outer connector for connecting the outer pipe to a further fluid handling component. The further fluid handling component may comprise a pipe, another vacuum-insulated pipe assembly, a fluid storage tank, a fluid consumer unit (such as an engine) and/or a fluid flow controller (such as a valve or pump).

Optionally, the second connector is engaged with the annular wall at an opposite side of the annular wall to the first connector. Optionally, the connection between the first and second connector parts urges each of the first and second connectors in opposing directions towards the annular wall, thereby to clamp the annular wall. This may assist in restricting a movement of the first and second connectors relative to the annular wall in an axial direction along the common general axis and/or in an orthogonal direction orthogonal to the common general axis.

Optionally, the inner and/or outer pipes are flexible pipes. Providing flexible inner and/or outer pipes may provide versatility in an arrangement of the inner and/or outer pipes relative to other fluid handling components, such as to connect other pipes, fluid storage tanks, fluid consumers and/or fluid flow controllers. This may be particularly valuable when an available space is restricted, such as on an aircraft.

A second aspect of the present invention provides a fluid distribution system comprising the pipe assembly of the first aspect of the present invention and a further fluid handling component. The further fluid handling component comprises a component connector and a fluid carrying portion. The outer pipe comprises an outer connector connected to the component connector of the further fluid handling component. The second connector is fluidically coupled to the fluid carrying portion.

Providing the outer connector, and the second connector extending through the aperture, allows the vacuum-insulated pipe assembly to be conveniently connected to a variety of types of further fluid handling component. For instance, the further fluid handling component may comprise a tank defining a chamber for storing fluid, the chamber defining the fluid carrying portion. The component connector may connect the outer connector to the outer wall of the tank, and the second connector may be fluidically coupled to the chamber, such as through an opening into the chamber.

It will be appreciated that the further fluid handling component may comprise a pipe, another vacuum-insulated pipe assembly, a fluid storage tank, a fluid consumer unit (such as an engine) and/or a fluid flow controller (such as a valve or pump).

Optionally, the further fluid handling component comprises an opening into the fluid carrying portion, and the second connector extends through the opening. Optionally, the fluid distribution system comprises a component seal element located between the second connector and the opening, to inhibit a flow of fluid from the fluid handling portion into an intermediate space surrounding the second connector via the opening. This may reduce a likelihood of fluid in the fluid handling portion, such as fluid from the inner pipe, passing into the intermediate space. Optionally, the second component extends through the opening in an interference fit with the opening. This may further reduce a likelihood of the fluid passing between the second connector and the opening. Optionally, the second component has a lower thermal expansion coefficient than the material defining the opening, further enhancing the seal in the presence of cryogenic fluid, as discussed above.

Optionally, the outer connector comprises a first flange, the component connector comprises a second flange, and the fluid distribution system comprises an outer seal element clamped between the outer connector and the component connector.

The outer seal element may inhibit a flow of fluid from an intermediate space surrounding the second connector to an atmosphere surrounding the outer connector. For example, in the event of a leak of fluid into the intermediate space along an interface between the second connector and the opening into the fluid carrying portion of the further fluid handling component, where provided, the outer seal element may prevent further passage of the leaked fluid from the intermediate space to the atmosphere surrounding the outer connector. This may be particularly advantageous where the fluid distribution system is configured to carry cryogenic hydrogen fuel and the atmosphere surrounding the outer connector comprises oxygen.

Optionally, the outer seal element comprises a metallic gasket. Optionally, at least one of the first and second flanges comprises a protrusion. Optionally, the protrusion is engaged with the metallic gasket such that the metallic gasket is plastically deformed in the region of the protrusion.

During connection of the first and second flanges to each other, the metallic gasket is clamped between the first and second flanges. A force provided by the clamping effect causes the protrusion to engage the metallic gasket and cause plastic deformation of the metallic gasket in the region of the protrusion. This may provide a work-hardening of the metallic gasket and improved sealing compared, for example, to an elastomeric seal element, as discussed above.

A third aspect of the present invention provides an aircraft fuel system comprising the vacuum-insulated pipe assembly of the first aspect of the present invention, or the fluid distribution system of the second aspect of the present invention. Optionally, the further fluid handling component comprises a fuel tank of the aircraft, such as a cryogenic hydrogen fuel tank. Optionally, the further fluid handling component comprises an engine of the aircraft, such as a hydrogen combustion engine and/or a hydrogen fuel cell of the aircraft.

A fourth aspect of the present invention provides an aircraft comprising the vacuum-insulated pipe assembly of the first aspect of the present invention, the fluid distribution system of the second aspect of the present invention, or the aircraft fuel system of the third aspect of the present invention.

A fifth aspect of the present invention provides a method of manufacturing a vacuum-insulated pipe assembly. The method comprises inserting an inner pipe into an outer pipe so that the inner pipe is distanced from the outer pipe to define a space. The vacuum-insulated pipe assembly comprises a first hollow connector connected to the inner pipe, and a second hollow connector. The outer pipe comprises an annular wall extending inwardly from the outer pipe and defining an aperture about a central axis. The method comprises: aligning the first connector with the aperture; passing at least a part of the second hollow connector through the aperture from an opposite side of the annular wall to the first connector; and connecting the at least a part of the second hollow connector to the first hollow connector such that the inner pipe is in fluid communication with the second hollow connector through the aperture.

By passing the at least a part of the second hollow connector through the aperture and connecting it to the first hollow connector, the first and second hollow connectors may be connected together even when the first hollow connector is located entirely on one side of the annular wall, and when access to the first hollow connector from within the outer pipe is restricted. The second hollow connector may be manipulated from an opposite side of the annular wall to the first hollow connector, providing a convenient way to manufacture the vacuum-insulated pipe assembly.

Optionally, the method comprises, before inserting the inner pipe into the outer pipe, providing a seal element on the head. Optionally, the method comprises, before inserting the inner pipe into the outer pipe, connecting a tool to the first hollow connector so that the tool holds the seal in place on the head. Optionally, the method comprises, after inserting the inner pipe into the outer pipe, locating the head on the annular wall so that the seal element is located between the head and the annular wall and the tool protrudes through the aperture.

The tool may reduce a likelihood of the seal element lifting away from the head during insertion of the inner pipe in the outer pipe, and may assist with locating the seal element between the head and the annular wall. By protruding through the aperture, the tool may also provide a convenient way of aligning the head with the aperture.

Optionally, the annular wall comprises a ring extending around the aperture. Optionally, the locating the head on the annular wall comprises locating the head in the ring. Optionally, the ring and head comprise reciprocal interlocking portions that restrict a relative rotation of the ring and the head about the common central axis. Optionally, the locating the head in the ring comprises mating the reciprocal interlocking portions.

Optionally, the method comprises, before passing the at least a part of the second hollow connector through the aperture and connecting the at least a part of the second hollow connector to the first hollow connector: disconnecting the tool from the first hollow connector; and removing the tool through the aperture. The tool may thereby be removed when the head is located on the annular wall, with the seal element between the head and the annular wall, to permit connection of the second hollow connector to the first hollow connector.

The seal element may be sized to extend around the aperture and to abut both the head of the first hollow connector and the annular wall surrounding the aperture. The tool may overlap the seal element when viewed along the common central axis, to prevent relative movement of the seal element and the head in a direction along the common central axis. This may help to retain the seal element on the head during insertion of the inner pipe into the outer pipe. The tool may be sized so as to not overlap the aperture when viewed along the common central axis, so that the tool can be removed through the aperture when the head is engaged with the annular wall.

Optionally, the tool and the first hollow connector comprise respective reciprocal threaded portions, and the connecting the tool to and/or the disconnecting tool from the inner pipe comprises rotating the tool, such as around the common central axis, relative to the first hollow connector to respectively engage and/or disengage the reciprocal threaded portions.

Optionally, the outer pipe comprises an outer connector, and the method comprises connecting the outer connector to a component connector of a further fluid handling component. Optionally, the method comprises fluidically coupling the second connector to a fluid carrying portion of the further fluid handling component, to fluidically connect the inner pipe with the fluid carrying portion of the further fluid handling component.

The method may comprise disassembling the vacuum-insulated pipe assembly, which may comprise any one or more of the following steps: disconnecting the outer connector and the component connector; uncoupling the inner pipe and the fluid carrying portion; disconnecting the second hollow connector from the first hollow connector; connecting the tool to the first hollow connector to retain the seal element between the tool and the head; removing the head from the annular wall; and removing the inner pipe from the outer pipe.

In this way, the method may allow the vacuum-insulated pipe assembly to be disassembled, such as to facilitate maintenance of the vacuum-insulated pipe assembly (or a fluid distribution system comprising the vacuum-insulated pipe assembly), or replacement of parts thereof.

A sixth aspect of the present invention provides a kit of parts for performing the method of the fifth aspect of the present invention, the kit of parts comprising the outer pipe, the inner pipe, and the first and second hollow connectors. The kit of parts may comprise any one or more of: the tool, the seal element; the outer seal element; and the further fluid handling component.

### BRIEF DESCRIPTION OF THE DRAWINGS

Embodiments of the invention will now be described, by way of example only, with reference to the accompanying drawings, in which:

FIG. 1 shows a schematic view of an example aircraft;

FIG. 2 shows a schematic view of an example hydrogen fuel system;

FIG. 3A shows a schematic view of an example vacuum-insulated pipe assembly;

FIG. 3B shows a schematic zoomed-in view of a part of the vacuum-insulated pipe assembly of FIG. 3A;

FIG. 4A shows a schematic view of an outer pipe of the vacuum-insulated pipe assembly, in isolation;

FIG. 4B shows a schematic view of an inner pipe and a first connector of the vacuum-insulated pipe assembly, in isolation;

FIG. 4C shows a schematic view of a second connector of the vacuum-insulated pipe assembly, in isolation;

FIG. 5A shows a schematic end-on view of an annular wall of the outer pipe when viewed along a common central axis;

FIG. 5B shows a schematic end-on view of a head end of the first connector when viewed along a common central axis;

FIG. 6A shows a first state in an example of the vacuum-insulated pipe assembly during manufacture of the vacuum-insulated pipe assembly;

FIG. 6B shows a second state in the example of the vacuum-insulated pipe assembly during manufacture of the vacuum-insulated pipe assembly;

FIG. 6C shows a third state in the example of the vacuum-insulated pipe assembly during manufacture of the vacuum-insulated pipe assembly;

FIG. 6D shows a fourth state in the example of the vacuum-insulated pipe assembly during manufacture of the vacuum-insulated pipe assembly;

FIG. 6E shows a fifth state in the example of the vacuum-insulated pipe assembly during manufacture of the vacuum-insulated pipe assembly;

FIG. 6F shows a sixth state in the example of the vacuum-insulated pipe assembly during manufacture of the vacuum-insulated pipe assembly; and

FIG. 7 shows an example method of manufacturing the vacuum-insulated pipe assembly.

### DETAILED DESCRIPTION OF THE PREFERRED EMBODIMENTS

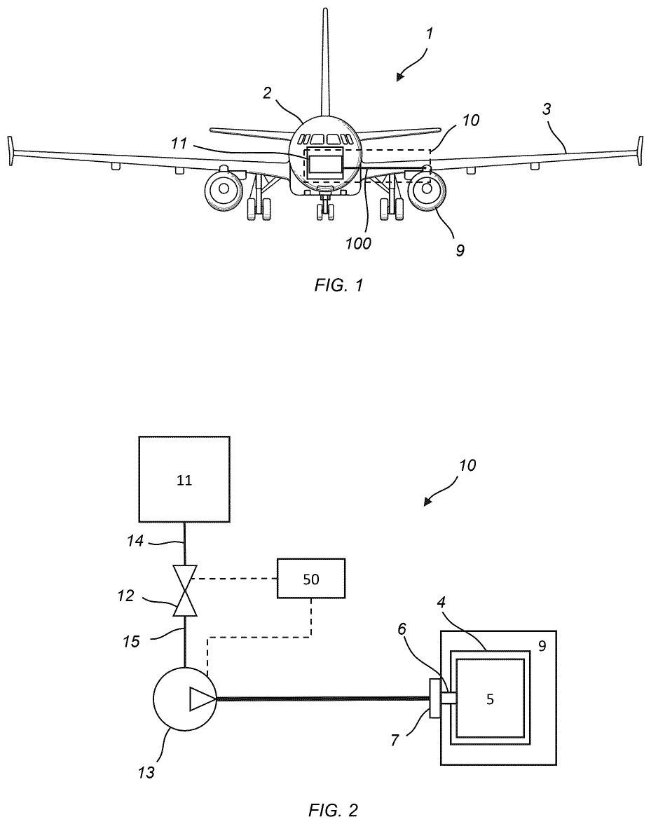

FIG. 1 shows an example aircraft 1 comprising a fuselage 2, a wing 3 and an engine 9 mounted on the wing 3. The aircraft 1 comprises a hydrogen fuel system 10 comprising a hydrogen fuel tank 11 storing cryogenic hydrogen fuel. The hydrogen fuel system 10 comprises a vacuum-insulated pipe assembly 100 fluidically connected between the hydrogen fuel tank 11 and the engine 9 (here shown as a single line, for ease of comprehension). The vacuum-insulated pipe assembly 100 is configured to provide hydrogen fuel to the engine 9. The hydrogen fuel tank 11 is located in the fuselage 2, and the vacuum-insulated pipe assembly 100 extends from the fuselage 2 along the wing 3 of the aircraft 1. The engine 9 comprises a combustion engine, but in other examples, the engine 9 may comprise a hydrogen fuel cell, which may generate electricity for powering a propulsor of the aircraft 1.

The hydrogen fuel system 10 is shown in more detail in FIG. 2. The hydrogen fuel system 10 comprises the hydrogen fuel tank 11 storing the cryogenic hydrogen fuel for the engine 9. The hydrogen fuel system 10 also comprises a valve 12, a pump 13, a first vacuum-insulated pipe 14 fluidically connecting the valve 12 to the hydrogen fuel tank 11, and a second vacuum-insulated pipe 15 fluidically connecting the pump 13 to the valve 14. The first and second vacuum-insulated pipes 14, 15 are shown as single lines for ease of comprehension. The hydrogen fuel system comprises a vacuum-insulated pipe assembly 100, shown in FIG. 2 as a single line for visual clarity, fluidically connecting the pump 13 to the engine 9.

The hydrogen fuel system 10 also comprises a controller 50 configured to operate the pump 13 and the valve 12 to selectively cause hydrogen fuel to flow through from the hydrogen fuel tank 11 to the engine 9 via the vacuum-insulated pipe assembly 100. It will be appreciated that the arrangement shown in FIG. 2 is exemplary only, and that in other examples the hydrogen fuel system 10 may comprise any other suitable arrangement of pumps, valves, vacuum-insulated pipe assemblies and/or other components for distributing fuel in the hydrogen fuel system 10.

The engine 9 comprises a receiver tank 4 comprising a tank chamber 5, a receiver tank opening 6 into the tank chamber 5 and a tank flange 7 (not shown in FIG. 2). The tank chamber 5 is fluidically coupled to the vacuum-insulated pipe assembly 100 to receive cryogenic hydrogen fuel from the vacuum-insulated pipe assembly 100. The tank chamber 5 stores the cryogenic hydrogen fuel for use by the engine 9.

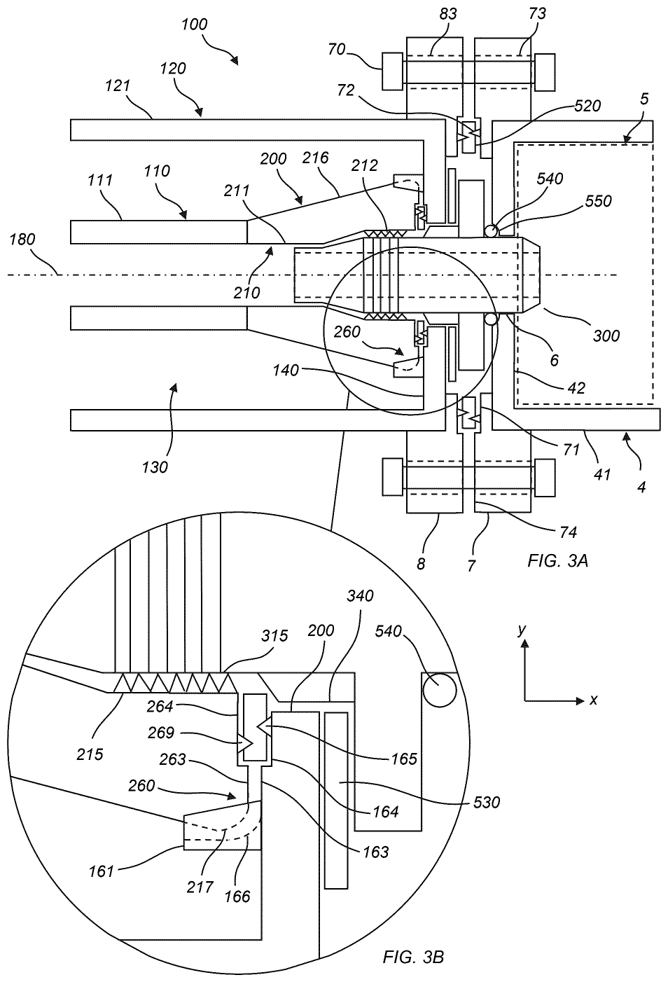

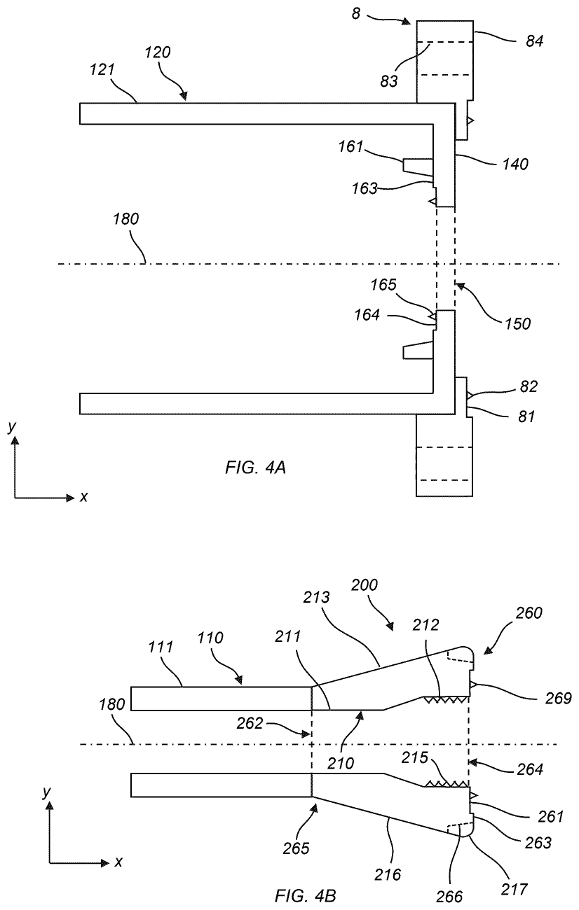

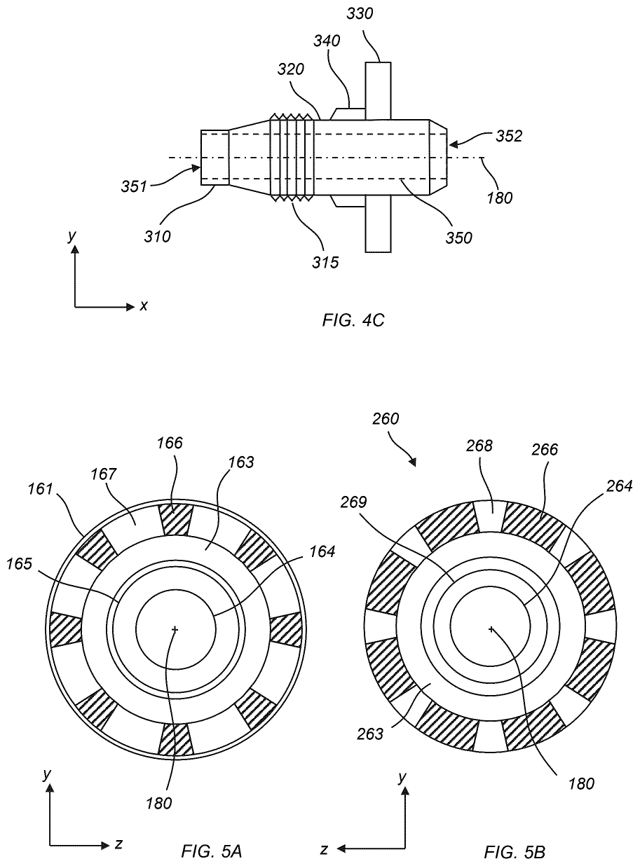

FIGS. 3A and 3B show the vacuum-insulated pipe assembly 100 connected to the engine 9, and FIGS. 4A to 4C show components of the vacuum-insulated pipe assembly 100 in isolation.

The receiver tank 4 of the engine 9 comprises a tubular tank wall 41 and an annular tank wall 42. The annular tank wall 42 is solid and extends inwardly from a free end of the tubular tank wall 41. The annular tank wall 42 defines the tank opening 6, which is concentric with a common central axis 180. The tank flange 7 is an annular member extending around and radially away from the free end of the tubular tank wall 41. The tank flange 7 has a tank flange surface 74, which is flat and orthogonal to the common central axis. The tank flange 7 also has an outer flange groove 81, which is similarly flat and orthogonal to the common central axis 180. The tank flange surface 74 is stepped away from the tank flange groove 81, in a direction away from the annular tank wall 42. The tank flange 7 also comprises a tank flange bolt holes 73 equally spaced apart in a circular array around the common central axis 180, the tank flange bolt holes 73 extending through the tank flange 7 in a direction along the common central axis 180.

The vacuum-insulated pipe assembly 100 comprises an outer pipe 120, an inner pipe 110 within the outer pipe 120, a space 130 between the inner pipe 110 and the outer pipe 120, an annular wall 140 extending radially inwardly from the outer pipe 120, an outer flange 8, a first connector 200, a second connector 300, a first metallic gasket 510, a second metallic gasket 520, a washer 530, and an elastomeric O-ring seal 540.

The outer pipe 120 is defined by an outer tubular wall 121 and the inner pipe 110 is defined by an inner tubular wall 111. The inner and outer tubular walls 111, 121 are concentric about the common central axis 180. The inner and outer tubular walls 111, 121 are radially spaced apart, and the space 130 is defined between the inner and outer tubular walls 111, 121. The annular wall 140 is a solid wall that depends radially inwardly from a free end of the outer tubular wall 121 and defines a closed end of the space 130. The annular wall 140 defines an aperture 150 that is concentric with the common central axis 180.

The vacuum-insulated pipe assembly 100 comprises a steel ring 161 on the annular wall 140, a wall surface 163, which is a surface of the annular wall 140 extending radially inwardly from the steel ring 161, and an annular wall groove 164 extending radially between the wall surface 163 and the aperture 150. The steel ring 161 extends around the aperture 150 and is concentric with the common central axis 180. The steel ring 161 protrudes away from the annular wall 140 and has a larger internal diameter than an internal diameter of the aperture 150. The wall surface 163 is flat and faces axially along the common central axis 180 towards the first connector 200. The wall surface 163 is stepped away from the annular wall groove 164 in a direction along the common central axis 180. A wall knife-edge protrusion 165 is provided on the annular wall groove 164. The wall knife-edge protrusion 165 is annular around the common central axis 180. As shown in FIG. 5A, the ring 161 comprises ring recesses 166 extending radially outwardly from an inner circumference of the ring 161. The ring recesses 166 are annulus-sector-shaped when viewed along the common central axis 180, and are evenly distributed around the common central axis 180. Ring protrusions 167 are defined between neighboring ring recesses 166. The ring protrusions 167 are similarly evenly distributed around the common central axis 180. The ring recesses 166 are shown schematically in a side-profile view using dashed lines in FIG. 3B.

The outer flange 8 is an annular member extending around the free end of the outer tubular wall 121. The outer flange 8 defines an outer flange surface 84, which is flat and faces in a first direction along the common central axis 180. The outer flange 8 also defines an outer flange groove 81, which is flat and faces in the first direction along the common central axis 180. The outer flange surface 84 is stepped away from the outer flange groove 81 in the first direction. The outer flange 8 comprises an outer knife-edge protrusion 82 on the outer flange groove 81. The outer flange 8 also comprises outer flange bolt holes 83 equally spaced apart in a circular array around the common central axis 180, the outer flange bolt holes 83 extending through the outer flange 8 in a direction along the common central axis 180.

The first connector 200 has a frustoconical body 213 formed of steel. The frustoconical body 213 is concentric with the common central axis 180, and defines a first conduit 210 extending therethrough along the common central axis 180. The first conduit 210 comprises a first conduit portion 211 and a second conduit portion 212. The first conduit portion 211 has a smaller internal diameter than the second conduit portion 212. The first connector 200 comprises an internal thread 215 on an internal wall of the second conduit portion 212. The frustoconical body 213 has a pipe end 265 defining a pipe opening 262 into the first conduit 210, a head end 260, opposite to the pipe end 265, and an outer surface 216 extending between the pipe end 265 and the head end 260 at an angle oblique to the common central axis 180. The head end 260 defines a head opening 264 into the first conduit 210. The head end 260 comprises a head groove 261, which is a flat surface extending radially away from the head opening 264. A head knife-edge protrusion 269 is provided on the head groove 261. The head knife-edge protrusion 269 is annular around the common central axis 180. The head end 260 also has a head surface 263, which is radially outward of the head groove 261 and stepped away from the head groove 261 in the first direction along the common central axis 180. The first connector 200 comprises a rounded edge 217 extending between the outer surface 216 and the head surface 263.

As shown in FIG. 5B, the head end 260 comprises head recesses 266 that extend radially inwardly from the rounded edge. The head recesses 266 are evenly distributed around the common central axis 180. Head protrusions 268 are defined between neighboring head recesses 266. The head protrusions 268 are similarly evenly distributed around the common central axis 180. The head recesses 266 and head protrusions 268 are annulus-sector-shaped when viewed along the common central axis 180. The head recesses 266 are disposed about the common central axis 180 at angular locations that correspond to angular locations of the ring protrusions 167 of the steel ring 161 about the common central axis 180. The head recesses 266 are sized and shaped to correspond to the size and shape of the corresponding ring protrusions 167 of the steel ring 161. The head recesses 266 are shown schematically in side-profile view using dashed lines in FIG. 4B. The ring recesses 166 of the steel ring 161 are sized and shaped to correspond to the size and shape of the corresponding head protrusions 268 of the head end 260.

The second connector 300, as best shown in FIG. 4C, comprises a first tubular wall 310 that defines a connector opening 351 and a second tubular wall 320 that defines a component opening 352. The first and second tubular walls 310, 320 form a unitary piece made of steel, and together define a second conduit 350 extending through the second connector 300 between the connector opening 351 and the component opening 352. The first tubular wall 310 has a smaller external diameter than the second tubular wall 320. The second connector 300 has an external thread 315 on an outer surface of the second tubular wall 320, and a flanged wall 330 taking the form of a solid annular disc extending radially outwardly from the second tubular wall 320. An external diameter of the flanged wall 330 is greater than an internal diameter of the aperture 150. Though not shown in the Figures, a peripheral surface of the flanged wall 330 is hexagonal when viewed along the common central axis 180. The second tubular wall 320 comprises a raised surface 340 located between the external thread 315 and the flanged wall 330. The raised surface 340 extends around the common central axis 180 and is stepped radially outwardly from the outer surface of the second tubular wall 320. A step extending between the raised surface 340 and the outer surface of the second tubular wall 320 is oblique to the common central axis 180, so that a taper is provided between the raised surface 340 and the outer surface of the second tubular wall 320.

The first and second metallic gaskets 510, 520 are annular copper discs concentric with the common central axis 180. The washer 530 is an annular steel disc concentric with the common central axis 180. The elastomeric O-ring seal 540 is a rubber O-ring (specifically a polytetrafluoroethylene (PTFE) O-ring) that is resilient under cryogenic conditions.

The relative positioning and connection of the components discussed above are now described in detail. The first connector 200 is welded to the inner tubular wall 111 so that the pipe opening 262, and thus the first conduit 210, is fluidically coupled to the inner tubular wall 111. The head opening 264 is coaxial with the aperture 150 along the common central axis 180. The head end 260 is engaged with the annular wall 160 such that the head protrusions 268 on the head end 260 interface with the ring recesses 166 on the steel ring 161 (and the ring protrusions 167 interface with the head recesses 266). This inhibits rotation of the first connector 200 around the common central axis 180 relative to the annular wall 140. The head surface 263 of the head end 260 contacts the wall surface 163 of the annular wall 140. The first metallic gasket 510 is clamped between the head groove 261 of the head end 260 and the annular wall groove 164 of the annular wall 140. The wall and head knife-edge protrusions 165, 269 penetrate the first metallic gasket 510 due to the clamping effect between the head groove 261 and the annular wall groove 164. The first metallic gasket 510 is plastically deformed in the region of the wall and head knife-edge protrusions 165, 269. In this way, the first metallic gasket 510 provides a seal at an interface between the head end 260 and the annular wall 140.

The second tubular wall 320 of the second connector 300 is disposed in the aperture 150, and the raised surface 340 contacts an internal wall of the aperture to restrict a relative radial movement of the second connector 300 in the aperture 150. The flanged wall 330 of the second connector 300 is located on a side of the annular wall 140 opposite to the first connector 200 and inner pipe 110. The second tubular wall 320 extends from the flanged wall 330 through the aperture 150 and into the first conduit 210 of the first connector 200 through the head opening 264. The external thread 315 of the second connector 300 is engaged with the internal thread 215 of the first connector 200 to connect the first connector 200 to the second connector 300. The first tubular wall 310 of the second connector 300 engages and forms an interference fit with an inner surface of the first conduit portion 211 of the first connector 200. This helps to both connect the second connector 300 to the first connector 200 and form a seal between the first tubular wall 310 and the inner surface of the first conduit portion 211. The connector opening 351 opens into the first conduit portion 211, thereby fluidically connecting the first conduit 210 and the second conduit 350. The interference fit inhibits a flow of fluid from the first conduit portion 211 towards the aperture 150 and the first metallic gasket 510 via an interface between the first and second connectors 200, 300.

The washer 530 is concentric with the common central axis 180 and is clamped between the annular wall 140 and the flanged wall 330 of the second connector 300. This distributes a stress exerted on the annular wall 140 by the flanged wall 330 due to a clamping force between the first and second connectors 200, 300.

The second tubular wall 320 of the second connector 300 extends through, and forms an interference fit with, the receiver tank opening 6 of the receiver tank 4. The elastomeric O-ring seal 540 is located in a seal recess 550 surrounding the receiver tank opening 6 and engages the flanged wall 330 of the second connector 300 to seal a space between the flanged wall 330 and the receiver tank 4. The interference fit and the elastomeric O-ring seal 540 thereby inhibit a flow of cryogenic hydrogen fuel from the tank chamber 5 of the receiver tank 4 to the connector space 130 between the outer pipe 120 and the receiver tank 4.

The outer flange 8 is connected to the tank flange 7 by bolts 70 extending through the outer flange bolt holes 83 and the tank flange bolt holes 73. The second metallic gasket 520 is clamped between the outer flange seal surface 81 and the tank flange seal surface 71. Due to a clamping force provided by the bolts 70, the tank and outer knife-edge protrusions 72,82 penetrate the second metallic gasket 520, and the second metallic gasket 520 is plastically deformed in the region of the tank and outer knife-edge protrusions 72, 82. In this way, the second metallic gasket 520 seals an interface between the outer flange 8 and the tank flange 7, which inhibits a flow of fluid from the connector space (e.g., cryogenic hydrogen fuel which has leaked across the second elastomeric O-ring seal 540) to an atmosphere external to the outer flange 8 and the tank flange 7.

The first connector 200, which is formed of steel, has a higher coefficient of thermal expansion than the second connector 300, which is formed of INVAR. This means that, as cryogenic hydrogen fuel is passed through the first and second conduits 210, 350, the first connector 200 will reduce in size to a greater extent than the second connector 300, which in turn will enhance the interference fit between the first tubular wall 310 of the second connector 300 and the first conduit portion 211 of the first connector 200.

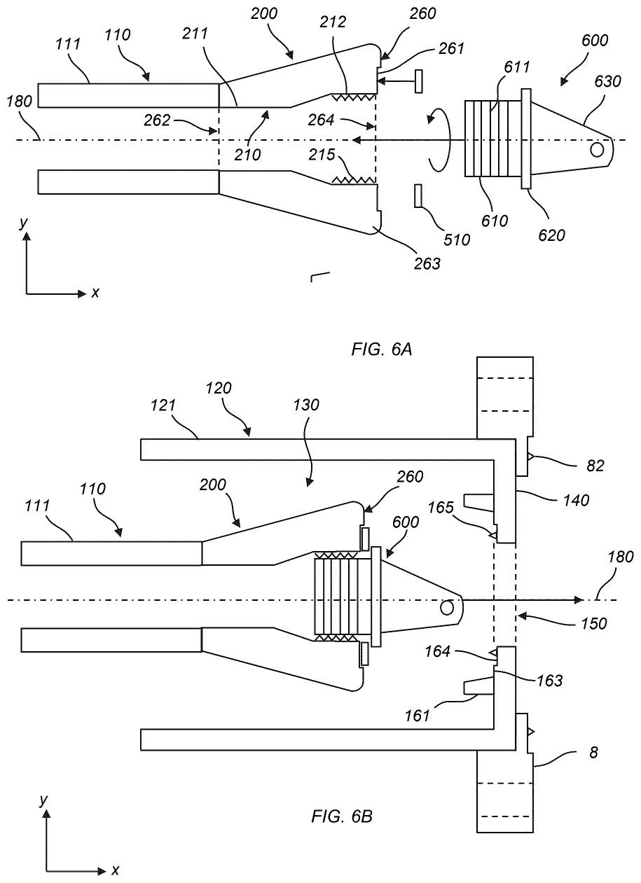

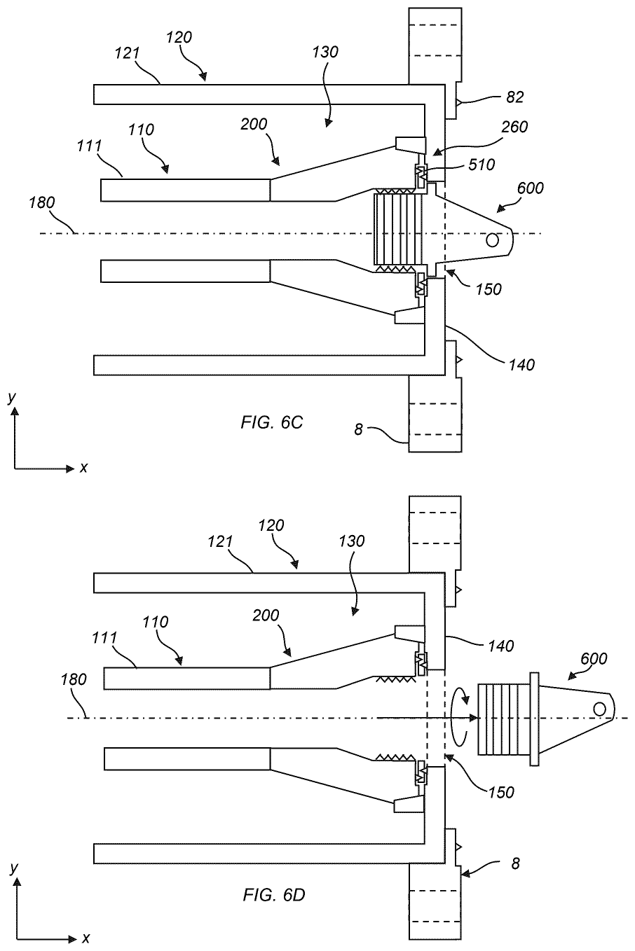

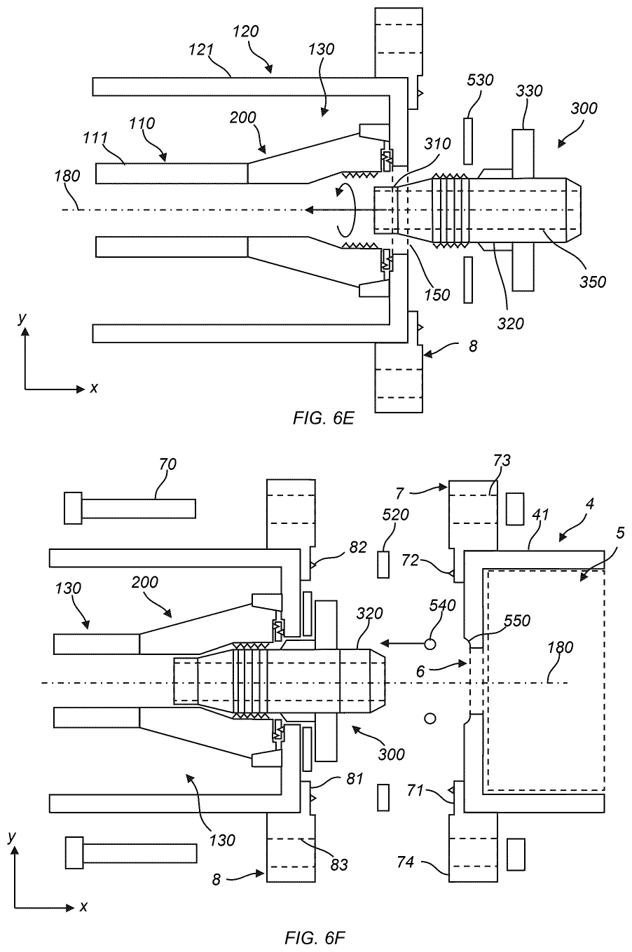

A process for assembling the vacuum-insulated pipe assembly 100 is now described with reference to FIGS. 6A to 6F. Starting with FIG. 6A, the first connector 200 is connected to the inner pipe 110 by welding, but may be connected to the inner pipe 110 in any other suitable way. The first metallic gasket 510 is located in the head groove 261.

Provided is a tool 600 comprising a threaded tube 610 extending away from an annular ridge 620, and a handle 630 connected to the annular ridge 620. The threaded tube 610 comprises an outer thread 611. The tool 600 is grasped by the handle 630 and inserted through the first metallic gasket 510 into the head opening 264 of the first connector 200 and is rotated around the common central axis 180 to screw the outer thread 611 of the tool 600 into the internal thread 215 of the first connector 200.

The annular ridge 620 has an external diameter that is greater than the internal diameter of the first metallic gasket 510, and contacts the first metallic gasket 510. This inhibits further movement of the tool 600 into the first conduit 210 and clamps the first metallic gasket 510 between the annular ridge 620 and the head groove 261. Thus, the tool 600 holds the first metallic gasket 510 in place in head groove 261 when the tool 600 is connected to the first connector 200. The outer pipe 120 is then passed over the inner pipe 110, the first connector 200 and the tool 600 (or equivalently the inner pipe 110, the first connector 200 and the tool 600 are inserted into the outer pipe 120).

As shown in FIG. 6C, the head end 260 of the first connector 200 is engaged with the annular wall 140 of the outer pipe 120, which restricts a radial and rotational motion, relative to the common central axis 180, of the first connector 200 relative to the annular wall 140. The internal diameter of the first metallic gasket 510 and the outer diameter of the annular ridge 620 are each less than an internal diameter of the aperture 150. This allows the annular ridge 620 to both hold the first metallic gasket 510 in place between the head groove 261 and the annular wall groove 164 whilst also fitting within the aperture 150 when the head end 260 is engaged with the annular wall 140. In this position, the handle 630 of the tool 600 extends through the aperture 150, allowing it to be grasped, such as by an operator, on an opposite side of the annular wall 140 to the inner pipe 110.

Turning to FIG. 6D, the tool 600 is rotated about the common central axis 180 to disconnect the tool 600 from the first connector 200. The tool 600 is then removed through the aperture 150, leaving the head end 260 engaged with the annular wall 140.

In FIG. 6E, the first and second tubular walls 310, 320 of the second connector 300 are passed through the washer 530 and inserted through the aperture 150 from an opposite side of the annular wall to the inner pipe 110 and the first connector 200. The second connector 300 is rotated about the common central axis 180 to engage the external thread 315 of the second connector 300 with the internal thread 215 of the first connector 200. It will be appreciated that the hexagonal cross-section of the peripheral surface of the flanged wall 330 provides a hexagonal bolt head on the second connector 300. In this way, hexagonal-shaped tools, such as spanners or sockets, can be used to screw the second connector 300 into the first connector 200, ensuring a secure fit.

Screwing the second connector 300 into the first connector 200 as such pulls the second connector 300 and the first connector 200 towards each other from either side of the annular wall 140. This causes the first tubular wall 310 of the second connector 300 to extend into the first conduit portion 211 of the first connector 200 to provide the interference fit between the first and second connectors 200, 300. Screwing the second connector 300 into the first connector 200 also causes the annular wall 140 to be clamped between the first and second connectors 200, 300 (specifically between the head end 260 of the first connector 200 and the flanged wall 330 of the second connector 300). In this way, connecting the first and second connectors 200, 300 exerts a force that clamps the first metallic gasket 510 between the head groove 261 and the annular wall groove 164. This causes the wall knife-edge protrusion 165 to penetrate and plastically deform the first metallic gasket 510, thereby providing the seal between the first connector 200 and the annular wall 140. Connecting the first and second connectors 200, 300 also exerts a force that clamps the washer 530 between the flanged wall 330 of the second connector 300 and the annular wall 140.

Finally, as best shown in FIG. 6F the outer flange 8 is offered up to the tank flange 7 of the receiver tank. The second metallic gasket 520 is positioned between the outer flange seal surface 81 and the tank flange seal surface 71. The elastomeric O-ring seal 540 is provided around the second tubular wall 320 in contact with the flanged wall 330. The outer flange 8 is brought towards the tank flange 7, and the second tubular wall 320 of the second connector 300 is inserted through the receiver tank opening 6 of the receiver tank 4. The interference fit between the second tubular wall 320 and the receiver tank opening 6, in combination with the elastomeric O-ring seal 540, provides the seal between the second connector 300 and the receiver tank opening 6. The bolts 70 are provided through the outer flange bolt holes 83 and the tank flange bolt holes 73, and the bolts 70 are tightened to connect the outer flange 8 to the tank flange 7. Tightening the bolts 70 exerts a force that clamps the second metallic gasket 520 between the outer flange seal surface 81 and the tank flange seal surface 71. This causes the outer knife-edge protrusion 82 to penetrate and plastically deform the second metallic gasket 520, thereby providing the seal between the outer flange 8 and the tank flange 7.

The above process provides the vacuum-insulated pipe assembly 100 in the configuration shown in FIGS. 3A and 3B. It will be appreciated that the process can be reversed to disconnect the outer pipe 120 from the receiver tank 4, and to remove the inner pipe 110 from the outer pipe 120. It will also be appreciated that each of the components of the vacuum-insulated pipe assembly, and in particular the inner pipe 110, the outer pipe 120, the first connector 200 and the second connector 300, may be provided as a kit of parts.

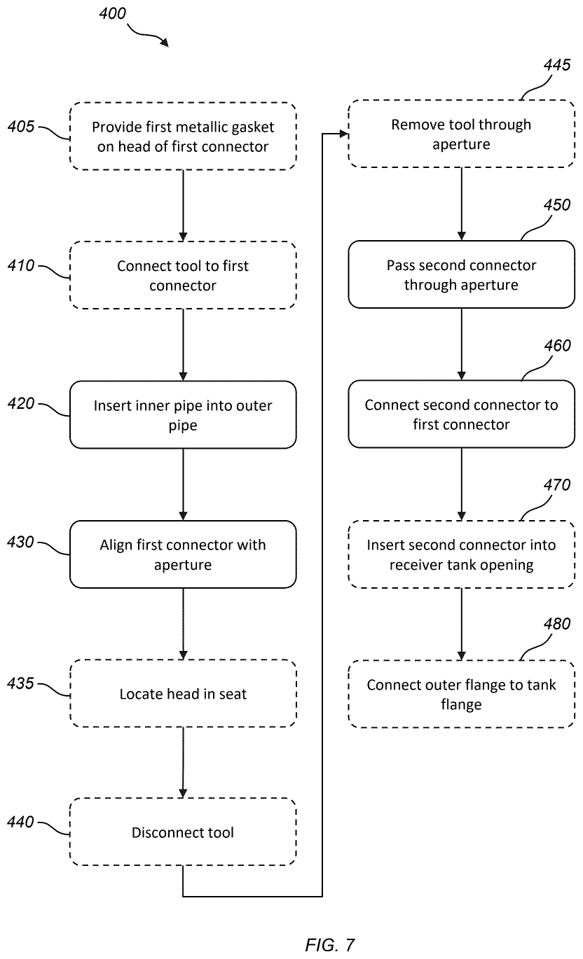

This process is exemplified by the method 400 of manufacturing the vacuum-insulated pipe assembly 100, shown in FIG. 7. The method 400 comprises inserting 420 the inner pipe 110 into the outer pipe 120 so that the inner pipe 110 is distanced from the outer pipe 120 to define the space 130. The method 400 also comprises aligning 430 the first connector 200 with the aperture 150 and passing 450 the second tubular wall 320 of the second connector 300 through the aperture 150 from an opposite side of the annular wall 140 to the first connector 200. The method 400 also comprises connecting 460 the external thread 315 of the second connector 300 to the internal thread 215 of the first connector 200, such that the inner pipe 110 is in fluid communication with the second conduit 350 through the aperture 150.

The method 400 also comprises, before inserting 420 the inner pipe 110 into the outer pipe 120, providing 405 the first metallic gasket 510 on the head end 260, and connecting 410 the tool 600 to the first connector 200 to hold the first metallic gasket 510 in place on the head end 260. The method 400 also comprises, after the inserting 420 the inner pipe 110 into the outer pipe 120 and aligning 430 the first connector 200 with the aperture 150, locating 435 the head end 260 on the annular wall 140 so that the first metallic gasket 510 is located between the head end 260 and the annular wall 140 (specifically between the head groove 261 and the annular wall groove 164), and the handle 630 of the tool 600 protrudes through the aperture 150.

The method 400 also comprises, after the locating 435 the head end 260 on the annular wall 140, and before the passing 450 the second tubular wall 320 of the second connector 300 through the aperture 150, disconnecting 440 the tool 600 from the first connector 200 and removing 445 the tool 600 through the aperture 150.

The method 400 then comprises inserting 470 the second tubular wall 320 into the receiver tank opening 6, to fluidically connect the inner pipe 110 with the tank chamber 5 via the first and second conduits 210, 350. The method 400 also comprises connecting 480 the outer flange 8 to the tank flange 7.

Various modifications may be made to the examples described above within the scope of the invention as defined in the appended claims. For instance, in some examples, the second connector 300 may not comprise the first tubular wall 310, and so may not provide an interference fit with the first conduit portion 211 of the first connector 200. In some such examples, the first connector 200 does not comprise the first conduit portion 211. In some such examples, the first and second conduits 210, 350 may have a constant diameter through the respective first and second connectors 200, 300.

Whilst the first connector 200 and second connector 300 have been described as being formed of steel and Invar, respectively, in other examples the first and second connectors 200, 300 may be formed of any other suitable material, including materials having the same coefficient of thermal expansion as each other. In some examples, the first and second connectors 200, 300 are formed of steel, and the second connector 300 comprises first and second INVAR tips defining the connector opening and the component opening, respectively. The second connector 300 with a steel body and INVAR tips may be manufactured with improved tolerance compared to a second connector 300 that is formed entirely of INVAR steel, whilst still providing the improved interference fit with the first conduit portion 211 of the first connector 200 and the opening 6 into the tank chamber 5. For instance, the external thread 315 may be more readily machined from steel than from INVAR, and so may be more precisely defined than an external thread of an INVAR second connector 300. The first and second INVAR tips may be welded to the respective first and second portions 310, 320.

The inner and outer pipes 110, 120 shown in the Figures are rigid pipes. In other examples, the inner and outer pipes 110, 120 comprise flexible portions, which may allow the inner and outer pipes 110, 120 to be connected between components of the hydrogen fuel system 10 having openings that are not aligned along a common central axis. For instance, the pump 13 (or another pipe assembly connected between the pump 13 and the engine 9) may comprise an outlet concentric with a pump axis, and the pump axis may be oblique to an axis with which the receiver tank opening 6 is concentric, such as the common central axis 180. In that case, the inner and outer pipes 110, 120 may curve to permit connection between the pump outlet and the receiver tank opening 6.

Whilst the first connector 200 has a frustoconical body 213, in other examples, the first connector 200 could take any other suitable shape. For instance, in some examples, the outer surface 216 of the first connector 200 may be parallel to the common central axis 180, and/or the head end 260 may be defined by an annular wall that extends away from the outer surface 216.

In some examples, one or more spacers are provided along a length of the inner pipe 110, the spacers comprising thin walls that extend radially away from the inner tubular wall 111 and contact an inner surface of the outer pipe 120. The spacers may distance the inner pipe 110 from the outer pipe 120 to define the space 130. Such spacers may be any suitable cross-sectional shape, such as circular, triangular, or quadrilateral. Such spacers may comprise one or more apertures through the thin walls to permit a vacuum to be provided along a full length of the space 130 between the inner pipe 110 and the outer pipe 120. In some examples, the inner and outer pipes 110, 120 are flexible hoses.

In some examples, the method 400 may comprise disassembling the vacuum-insulated pipe assembly 100. This may comprise, for instance, disconnecting the outer flange 8 from the tank flange 7, uncoupling the second tubular wall 320 from the receiver tank opening 6, disconnecting the second connector 300 from the first connector 200, connecting the tool 600 to the first connector 200 to retain the first metallic gasket 510 between the tool 600 and the head end 260, removing the head end 260 from the annular wall 140, and removing the inner pipe 110 from the outer pipe 120.

It is to be noted that the term “or” as used herein is to be interpreted to mean “and/or”, unless expressly stated otherwise.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A vacuum-insulated pipe assembly comprising:
an outer pipe and an inner pipe within the outer pipe, the inner pipe distanced from the outer pipe to provide a space, the space evacuated to define a vacuum;
an annular wall extending inwardly from the outer pipe and defining an aperture about a central axis, the annular wall defining a closed end of the space;
a first connector connected to the inner pipe; and
a second connector extending through the aperture and connected to the first connector,
wherein the first connector and the second connector are each hollow and connected such that the inner pipe is in fluid communication with the second connector through the aperture.

2. The vacuum-insulated pipe assembly of claim 1, wherein the first connector and the second connector comprise reciprocal threaded portions connecting the first connector to the second connector.

3. The vacuum-insulated pipe assembly of claim 1, wherein the second connector is connected in an interference fit with the first connector.

4. The vacuum-insulated pipe assembly of claim 1, wherein one of the first connector and the second connector comprises a material with a higher coefficient of thermal expansion than the other of the first connector and the second connector, and
wherein the one of the first connector and the second connector with the material with the higher coefficient of thermal expansion forms an interference fit with the other of the first connector and the second connector.

5. The vacuum-insulated pipe assembly of claim 1, wherein the annular wall comprises a ring extending around the aperture, and
wherein the first connector comprises a head engaged with the ring such that an opening of the first connector is aligned with the aperture along a common central axis.

6. The vacuum-insulated pipe assembly of claim 5, wherein the ring and the head comprise reciprocal interlocking elements that inhibit relative rotation of the head and the ring around the common central axis.

7. The vacuum-insulated pipe assembly of claim 5, further comprising:
a seal element located between the head and the annular wall, the seal element sealing an interface between the head and the annular wall such that the space and the aperture are fluidically isolated.

8. The vacuum-insulated pipe assembly of claim 7, wherein the seal element comprises a metallic gasket,
wherein at least one of the head and the annular wall comprises a protrusion, and
wherein the protrusion is engaged with the metallic gasket such that the metallic gasket is plastically deformed in a region of the protrusion.

9. A fluid distribution system comprising:
the vacuum-insulated pipe assembly of claim 1; and
a fluid handling component,
wherein the fluid handling component comprises a component connector and a fluid carrying portion,
wherein the outer pipe comprises an outer connector connected to the component connector of the fluid handling component, and
wherein the second connector is fluidically coupled to the fluid carrying portion.

10. The fluid distribution system of claim 9, wherein the outer connector comprises a first flange,
wherein the component connector comprises a second flange, and
wherein the fluid distribution system further comprises:
an outer seal element clamped between the outer connector and the component connector.

11. The fluid distribution system of claim 10, wherein the outer seal element comprises a metallic gasket,
wherein at least one of the first flange and the second flange comprises a protrusion, and
wherein the protrusion is engaged with the metallic gasket such that the metallic gasket is plastically deformed in a region of the protrusion.

12. An aircraft fuel system comprising:
the vacuum-insulated pipe assembly of claim 1.

13. An aircraft comprising:
the aircraft fuel system of claim 12.

14. A method of manufacturing a vacuum-insulated pipe assembly, the method comprising:
inserting an inner pipe into an outer pipe so that the inner pipe is distanced from the outer pipe to define a space, wherein the vacuum-insulated pipe assembly comprises a first hollow connector connected to the inner pipe, and a second hollow connector, and wherein the outer pipe comprises an annular wall extending inwardly from the outer pipe and defining an aperture about a central axis;
aligning the first connector with the aperture;
passing at least a part of the second hollow connector through the aperture from an opposite side of the annular wall to the first connector; and
connecting the at least a part of the second hollow connector to the first hollow connector such that the inner pipe is in fluid communication with the second hollow connector through the aperture.

15. The method of claim 14, wherein the first hollow connector comprises a head, and
wherein the method further comprises before inserting the inner pipe into the outer pipe:
providing a seal element on the head; and
connecting a tool to the first hollow connector so that the tool holds the seal in place on the head; and
wherein the method further comprises, after inserting the inner pipe into the outer pipe:
locating the head on the annular wall so that the seal element is located between the head and the annular wall and the tool protrudes through the aperture.

16. The method of claim 15, further comprising, before passing the at least a part of the second hollow connector through the aperture and connecting the at least a part of the second hollow connector to the first hollow connector:
disconnecting the tool from the first hollow connector; and
removing the tool through the aperture.

17. A kit of parts for performing the method of claim 14, the kit of parts comprising:
the outer pipe, the inner pipe, and the first hollow connector and the second hollow connector.
